(19) United States
(12) Patent Application Publication
(10) Pub. No.: US 2015/0178660 A1
(43) Pub. Date: Jun. 25, 2015

(54) SYSTEM AND METHOD FOR AUTOMATED OPTIMIZATION OF OPERATIONS IN A CONTACT CENTER

(71) Applicant: Avaya Inc., Basking Ridge, NJ (US)

(72) Inventors: Dawid Nowak, Dublin (IE); Neil O'Connor, Galway (IE); Joseph Smyth, Galway (IE)

(73) Assignee: Avaya Inc., Basking Ridge, NJ (US)

(21) Appl. No.: 14/133,898

(22) Filed: Dec. 19, 2013

(51) Int. Cl. G06Q 10/06

(52) U.S. Cl. CPC G06Q 10/06398

(57) ABSTRACT

A skill finding system for automated administration of employee's skills in an enterprise is provided. The skill finding system includes a selection module configured to select at least one employee of the enterprise for skill mutation from an employee database. The skill finding system further includes a mutation module configured to mutate at least one attribute of skill of the selected at least one employee based on predefined mutation rules. The skill finding system further includes an update module configured to terminate or retain the mutated at least one attribute of skill from the employee database based on at least one performance feedback of the selected employee and level of mutation in the selected employee's at least one attribute of skill.

### BACKGROUND

1. Field of the Invention

Embodiments of the present invention generally relate to a system and method for automated administration of employees skills in an enterprise and particularly to a system and method for automated administration of employees skills using mutation.

2. Description of Related Art

Contact centers are employed by many enterprises to service inbound and outbound telephonic calls from customers. A typical contact center includes a switch and/or server to receive and route incoming packet-switched and/or circuit-switched calls and one or more resources, such as human agents and automated resources (e.g., Interactive Voice Response (IVR) units), to service the incoming calls. Contact centers distribute calls, whether inbound or outbound, for servicing to any suitable resource according to certain predefined criteria. Normally, Automatic Call Distribution (ACD) system's controller is responsible for routing calls to suitable agents based on knowledge of agent's skills and objectives of incoming calls. In case if the ACD detects that there are no agents available with a specific skill for handling a particular call then the call is generally placed in queues to wait till an agent becomes available to service the call. This process is undesirable for the callers/customers of the contact centers.

Further, with time skills of certain agents may get better and some agents may even acquire new skills. Moreover, some agents might lose certain unpractised skills. Such change in the skills of the agents is necessary to be updated to the ACD as the ACD routes calls to the agents based on stored information corresponding to agent's skills. In modern contact centres, such task is managed by trained technicians and supervisors of the contact centers. The supervisors are responsible to manually administer change in skills of the agents and the trained technicians update the administered information to the ACD. However, this technique is adequate only for contact centers with small and limited number of agents. As number of agents grows in a contact center, manual administration of skills of agents becomes more and more difficult and complex. Further, manual update of the ACD is a crucial and time consuming process as human intervention is generally slow. Therefore, manual administration of agents could lead to suboptimal utilization of contact center resources.

There is thus a need for a system and method to automate the process of administration of skills of the agents of the contact center.

### SUMMARY

Embodiments in accordance with the present invention provide a skill finding system for automated administration of employees in an enterprise. The skill finding system includes a selection module configured to select at least one employee of the enterprise for skill mutation. The skill finding system further includes a mutation module configured to mutate at least one attribute of skill of the selected at least one employee based on predefined mutation rules. The skill finding system further includes an update module configured to update an employee database based on performance feedback of the selected at least one employee related to the mutated attribute of skill. The update module is further configured to update the employee database by terminating the mutation from the mutated attribute of skill based on negative performance feedback of the selected at least one employee. The update module is further configured to add the mutated attribute of skill in the employee database based on positive performance feedback of the selected at least one employee.

Embodiments in accordance with the present invention further provide a computer-implemented method for automated administration of employees in an enterprise. The computer-implemented method includes selecting at least one employee data from an employee database and retrieving at least one attribute of skill from the selected data, mutating the selected at least one attribute of skill based on predefined mutation rules, analysing performance of the at least one employee in a work related to the mutated attribute of skill, and updating the mutated data in the employee database based on the analyzed performance of the at least one employee in the mutated data.

Embodiments in accordance with the present invention further provide a computer-implemented method for automated administration of employees in an enterprise. The computer-implemented method includes selecting at least one employee data from an employee database and retrieving at least one attribute of skill from the selected data, mutating the selected at least one attribute of skill based on predefined mutation rules, analysing performance of the at least one employee in a work related to the mutated attribute of skill, and updating the mutated data in the employee database based on the analyzed performance of the at least one employee and a level of mutation in the mutated data.

The present invention can provide a number of advantages depending on a particular configuration. First, the system and the method disclosed by the present invention provides for proactively creating agent skills using mutation and then testing in the work-resource matching environment. The present invention provides a system and method to discover information related to new skills acquired by the agents

Next, the present invention focuses to test a large number of mutations in skills of contact center's agents. Therefore, over period of time ‘bad mutations’ or mutations for which obtained feedback is negative would be terminated and ‘good mutations’ would be kept ensuring that most optimal combination of skill attributes are assigned to each agent. Furthermore, the present invention has application in any enterprise in addition to traditional contact center. Any enterprise, that requires automatic management and administration of their employees' skills, may use the present invention to speed up and automate various roles of contact center's administrator and supervisors.

These and other advantages will be apparent from the disclosure of the present invention contained herein.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 is a block diagram depicting a contact center according to an embodiment of the present invention;

FIG. 2 is a block diagram of a server according to an embodiment of the present invention;

FIG. 3 is a block diagram depicting configuration of a skill finding system in a contact center according to an embodiment of the present invention;

FIG. 4 is an illustration of an exemplary data structure of a mutation table stored in an agent database; and

FIG. 5 is a flowchart of a method depicting an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The present invention will be illustrated below in conjunction with an exemplary communication system, e.g., the Avaya Aura® system. Although well suited for use with, e.g., a system having an ACD or other similar contact processing switch, the present invention is not limited to any particular type of communication system switch or configuration of system elements. Those skilled in the art will recognize the disclosed techniques may be used in any communication application in which it is desirable to provide improved contact processing.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a PBX, an ACD, an enterprise switch, or other type of communications system switch or server, as well as other types of processor-based communication control devices such as media servers, computers, adjuncts, etc.

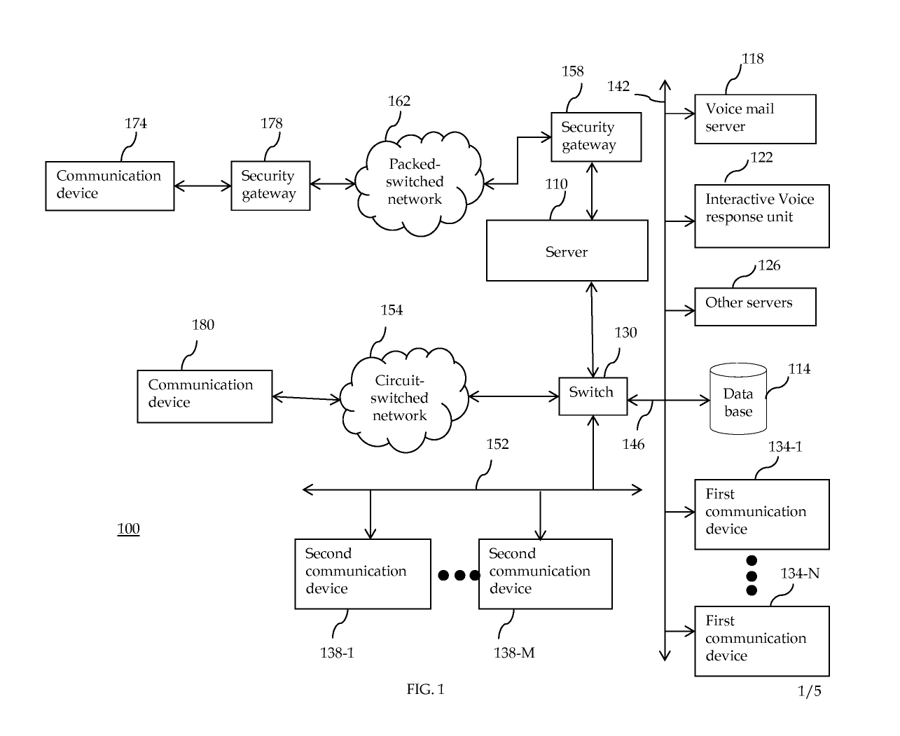

FIG. 1 shows an illustrative embodiment of the present invention. A contact center 100 comprises a central server 110, a set of data stores or databases 114 containing contact or customer related information and other information that can enhance the value and efficiency of the contact processing, and a plurality of servers, namely a voice mail server 118, an Interactive Voice Response unit (e.g., IVR) 122, and other servers 126, a switch 130, a plurality of working agents operating packet-switched (first) communication devices 134-1 to N (such as computer work stations or personal computers), and/or circuit-switched (second) communication devices 138-1 to M, all interconnected by a Local Area Network (LAN) or Wide Area Network (WAN) 142. The servers can be connected via optional communication lines 146 to the switch 130. As will be appreciated, the other servers 126 can also include a scanner (which is normally not connected to the switch 130 or Web server), VoIP software, video call software, voice messaging software, an IP voice server, a fax server, a web server, an email server, and the like. The switch 130 is connected via a plurality of trunks (not shown) to the Public Switch Telephone Network (PSTN) 154 and via link(s) 152 to the second communication devices 138-1 to M. A gateway 158 is positioned between the server 110 and the packet-switched network 162 to process communications passing between the server 110 and the network 162.

Although the preferred embodiment is discussed with reference to a client-server architecture, it is to be understood that the principles of the present invention apply to other network architectures. For example, the present invention applies to peer-to-peer networks, such as those envisioned by the Session Initiation Protocol. In the client-server model or paradigm, network services and the programs used by end users to access the services are described. The client side provides a user with an interface for requesting services from the network, and the server side is responsible for accepting user requests for services and providing the services transparent to the user. By contrast in the peer-to-peer model or paradigm, each networked host runs both the client and server parts of an application program. Additionally, the present invention does not require the presence of packet- or circuit-switched networks.

Further, as shown in FIG. 1, the gateway 158 can be Avaya Inc.'s, G700 Media Gateway™ and may be implemented as hardware such as via an adjunct processor (as shown) or as a chip in the server. The first communication devices 134-1, . . . 134-N are packet-switched and can include, for example, IP hardphones such as the Avaya Inc.'s, 4600 Series IP Phones™, IP softphones such as Avaya Inc.'s, IP Softphone™, Personal Digital Assistants or PDAs, Personal Computers or PCs, laptops, packet-based H.320 video phones and conferencing units, packet-based voice messaging and response units, packet-based traditional computer telephony adjuncts, peer-to-peer based communication devices, and any other communication device.

The second communication devices 138-1, . . . 138-M are circuit-switched. Each of the communication devices 138-1, . . . 138-M corresponds to one of a set of internal extensions Ext1, . . . ExtM, respectively. The second communication devices can include, for example, wired and wireless telephones, PDAs, H.320 videophones and conferencing units, voice messaging and response units, traditional computer telephony adjuncts, and any other communication device.

It should be noted that the present invention does not require any particular type of information transport medium between switch or server and first and second communication devices, i.e., the present invention may be implemented with any desired type of transport medium as well as combinations of different types of transport channels.

The packet-switched network 162 can be any data and/or distributed processing network, such as the Internet. The network 162 typically includes proxies (not shown), registrars (not shown), and routers (not shown) for managing packet flows.

The packet-switched network 162 is in communication with a first communication device 174 via a gateway 178, and the circuit-switched network 154 with an external second communication device 180.

In a preferred configuration, the server 110, network 162, and first communication devices 134 are Session Initiation Protocol or SIP compatible and can include interfaces for various other protocols such as the Lightweight Directory Access Protocol or LDAP, H.248, H.323, Simple Mail Transfer Protocol or SMTP, IMAP4, ISDN, E1/T1, and analog line or trunk.

It should be emphasized that the configuration of the switch, server, user communication devices, and other elements as shown in FIG. 1 is for purposes of illustration only and should not be construed as limiting the present invention to any particular arrangement of elements.

As will be appreciated, the central server 110 is notified via LAN 142 of an incoming work item by the communications component (e.g., switch 130, fax server, email server, web server, and/or other server) receiving the incoming work item. The incoming work item is held by the receiving telecommunications component until the server 110 forwards instructions to the component to forward or route the contact to a specific contact center resource, such as the IVR unit 122, the voice mail server 118, and/or first or second telecommunication device 134, 138 associated with a selected agent. The server 110 distributes and connects these work items to telecommunication devices of available agents based on the predetermined criteria noted above. When the central server 110 forwards a voice contact (or first work item) to an agent, the central server 110 also forwards customer-related information from databases 114 to the agent's computer work station for viewing (such as by a pop-up display) to permit the agent to better serve the customer.

Depending on the contact center configuration, the central server may forward a list of work items to an available agent to preview before forwarding the work item itself and the data associated therewith to the agent. The agents process the work items or contacts sent to them by the central server 110. This embodiment is particularly suited for a Customer Relationship Management (CRM) environment in which customers are permitted to use any media to contact a business. In a CRM environment, both real-time and non-real-time contacts must be handled and distributed with equal efficiency and effectiveness. In an embodiment of the present invention, customer executives of any enterprise may be referred to as ‘agents’, wherein customer executives are those employees of enterprises who provide support or services to customers of their enterprises via telephonic or electronic communication medium.

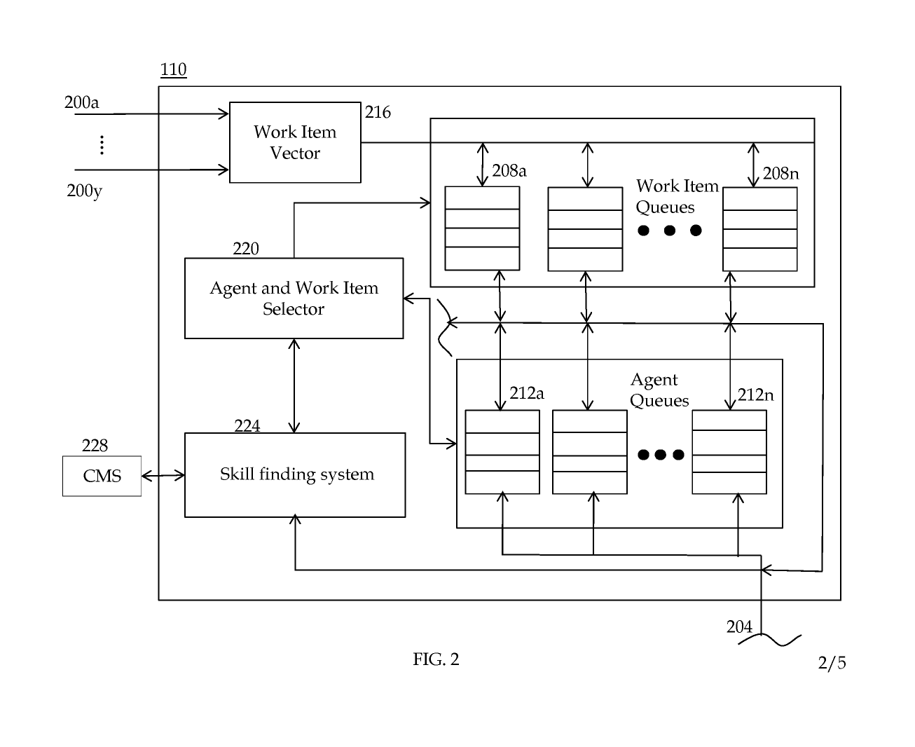

Referring to FIG. 2, one possible configuration of the server 110 is depicted. The server 110 is in communication with a plurality of customer communication lines 200a-y (which can be one or more trunks, phone lines, etc.) and agent communication line 204 (which can be a voice-and-data transmission line such as LAN 142 and/or a circuit switched voice line). The server 110 can include Avaya Inc.'s an Operational Analyst™ with On-Line Analytical Processing or OLAP technology or a Call Management System or CMS 228 that gathers contact records and contact-center statistics for use in generating contact-center reports. OA and CMS will hereinafter be referred to jointly as CMS 228.

The switch 130 and/or server 110 can be any architecture for directing contacts to one or more communication devices. In some embodiments, the switch 130 may perform load-balancing functions by allocating incoming or outgoing contacts among a plurality of logically and/or geographically distinct contact centers. Illustratively, the switch and/or server can be a modified form of the subscriber-premises equipment sold by Avaya Inc. under the names Definity™ Private-Branch Exchange (PBX)-based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya or another company. Typically, the switch/server is a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide automatic contact-distribution functionality. Other types of known switches and servers are well known in the art and therefore not described in detail herein.

As can be seen in FIG. 2, included among the data stored in the server 110 is a set of work item queues 208a-n and a separate set of agent queues 212a-n. Each work item queue 208a-n corresponds to a different set of agent queues, as does each agent queue 212a-n. Conventionally, work items are prioritized and either are enqueued in individual ones of the work item queues 208a-n in their order of priority or are enqueued in different ones of a plurality of work item queues that correspond to a different priority. Likewise, each agent's skills are prioritized according to his or her level of expertise in that skill, and either agents are enqueued in individual ones of agent queues 212a-n in their order of expertise level or are enqueued in different ones of a plurality of agent queues 212a-n that correspond to a skill and each one of which corresponds to a different expertise level.

According to the present invention, included among the programs executing on the server 110 are an agent and work item selector 220 (hereinafter, may be referred as ‘selector 220’) and the skill finding system 224. The selector 220 and the skill finding system 224 are stored either in the main memory or in a peripheral memory (e.g., disk, CD ROM, etc.) or some other computer-readable medium of the contact center 100. The selector 220 and the skill finding system 224 collectively effect an assignment between available work items (or contacts) and suitability of agents in a way that tends to maximize contact center performance for the current contact center state. The selector 220 uses predefined criteria in selecting an appropriate agent to service the work item. The selector 220 further assists the work item vector 216 in routing the contacts to the appropriate queue 208. The selector 220 also routs contacts to most suitable agent in the queue 212. The agent and customer profiles are typically maintained and updated by a profile generator (not shown). Upon the completion of handling a work item, the generator collects selected metrics for the work item. These metrics include the skill involved in servicing the work item. Each agent profile typically includes metrics associated with a plurality of work items serviced by the agent for each agent skill, and each customer profile includes metrics associated with a plurality of contacts by the customer.

Included among the control programs in the server 110 is a work item vector 216. Contacts incoming to the contact center are assigned by the work item vector 216 to different work item queues 208a-n based upon a number of predetermined criteria, including customer identity, customer needs, contact center needs, current contact center queue lengths, customer value, and the agent skill that is required for the proper handling of the contact. Agents who are available for handling work items are assigned to agent queues 212a-n based upon the skills that they possess. An agent may have multiple skills, and hence may be assigned to multiple agent queues 212a-n simultaneously. Furthermore, an agent may have different levels of skill expertise (e.g., skill levels 1-N in one configuration or merely primary skill levels and secondary skill levels in another configuration), and hence may be assigned to different agent queues 212a-n at different expertise levels.

Further, the agents may have certain skills that may not be known to the contact center and/or to the agents themselves. The contact center may be benefited by harvesting such skills. Such skills if known by the contact center can be used in case of extremities when the contact center runs out of agents with relevant skills. Furthermore, there may be a case where some agents may either enhance or lose some of their known skills (known by the contact center) with passage of the time or may even acquire new skill sets. Even in such cases it is very crucial for the contact center to track migrations in the skills of their agents to ensure optimum usage of their agent's skills and to provide a pleasant service experience to their customers.

In an embodiment of the present invention, the contact center 110 may use a skill finding system 224 (as shown in FIG. 2) to automatically find such newly acquired skills or updated skills of the contact center's agents. In an embodiment, the skill finding system 224 may be based on mutation (similar to biological principles of genetic mutation). For example, as mutation (addition, deletion, merging, pruning, or rearrangement of chromosomes) in a DNA (Deoxyribonucleic acid) can result into a new species of the DNA, similarly based on the same principle, the skill finding system 224 may be configured to discover new or updated skills of the agents in a contact center by testing a variation of other skills on the agents. For example, if an agent is known to be skilled in selling refrigerators, water coolers, and air conditioners. The agent can also be tested in sales of water heaters or blowers. Based on performance of the agent in selling the water heaters or blowers, it can be determined whether or not the agent can be used in future for the sales of the water heaters or blowers.

In an exemplary embodiment of the present invention, information corresponding to the existing skills of the agents may be pre-stored in a database (such as the CMS 228) of the contact center 110. Further, as explained earlier in the present invention, the selector 220 is configured to select an agent for attending a work item based on a match between skills of the agent and skills required to handle the work item. The skill finding system 224 takes advantage of such configuration of the selector 220, as the skill finding system 224 is configured to mutate (add, delete, modify) the skill information (of one or more agents of the contact center) pre-stored in the database based on certain mutation rules. In an embodiment of the present invention, the mutation rules include random addition, deletion, and modification of skill information (stored in a database).

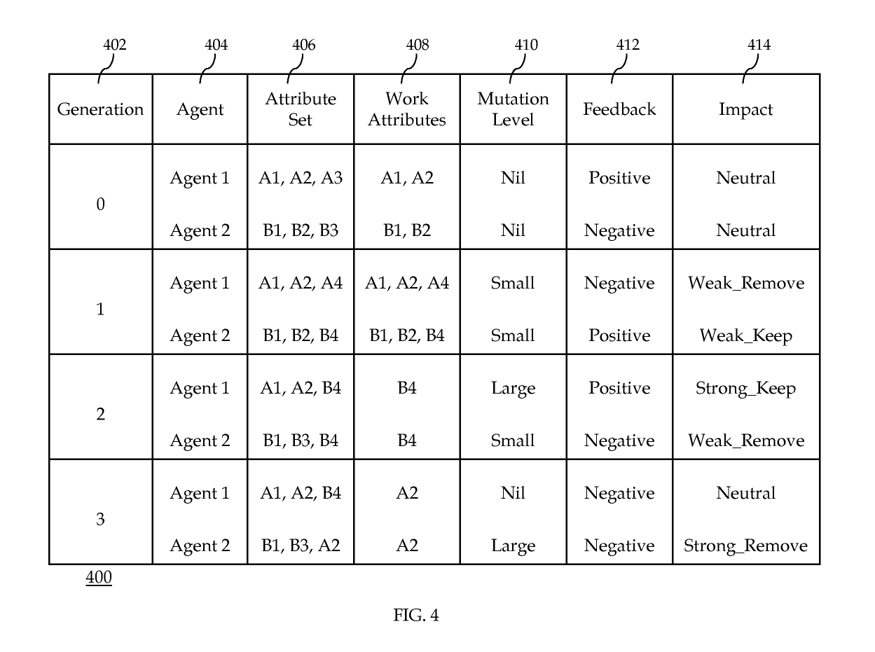

In an embodiment, the mutation in the skills of the agents can be tested when a work item related to a mutated skill set arrives and the selector 220 routes the work item to an agent with mutated skills. Performance of the agent (with the mutated skills) in handling the work item may be monitored by the skill finding system 224 to determine whether to delete or retain the mutation in the skills of the agent. In an embodiment, if the performance of the agent is above an acceptable level then the mutation in the skills of the agent may be considered as a successful mutation and such mutation must be retained. Otherwise the mutation in the skills must be dropped. In an exemplary embodiment of the present invention, level of mutation in the skills of the agents also plays a significant role in determining whether the mutation should be terminated or retained. The significance of the level of mutation in the skills of an agent is detailed further in conjunction with the FIG. 4 of the present invention.

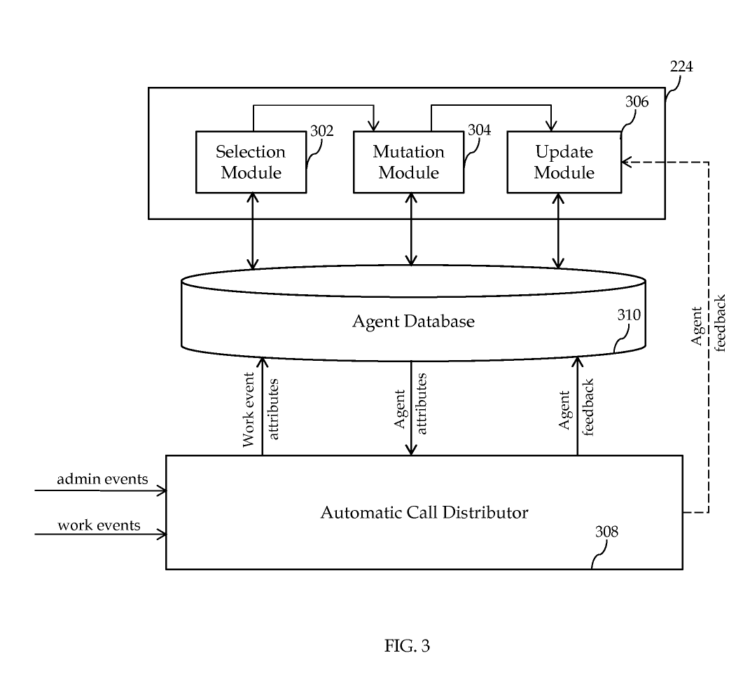

FIG. 3 is a block diagram depicting configuration of the skill finding system 224 in a contact center 110 according to an embodiment of the present invention. As shown, the skill finding system 224 includes a selection module 302, a mutation module 304, and an update module 306. The operation of the selection module 302, mutation module 304, and update module 306 will be discussed further in reference with the FIG. 3. As shown, the skill finding system 224 and the automatic call distributor 308 are in communication with an agent database 310 (or employee database 310).

In an embodiment, the agent database 310 stores all information pertaining to agents, customers, and communication between the agents and the customers of the contact center 110. For example, the agent database 310 may include personal and professional information related to agents and customers of the contact center 110. The professional information of the agents may include known skill sets of the agents, wherein the skill sets relates to skills which are required to handle customers of the contact center 110. Further, the database 310 may also include performance feedback for the agents of the contact centers that may either be provided by the customers of the contact centers or may even be automatically analyzed based on communication between the agents and the customers of the contact center 110.

Further, as shown, the selection module 302 of the skill finding system 224 is in communication with the agent database 310. In an embodiment, the selection module 302 is configured to select at least one agent or a group of agents (or employees) from the agent database 310 for mutating their skills (which are pre-stored in the database 310). In an embodiment, the selection module may relay on certain pre-set selection rules for selecting at least an agent or a group of agents from a list of all agents working for the contact center. In another embodiment, the selection module may take input from administrator to for selection of at least one agent. Further, the pre-set rules may include, but is not restricted to, selection of agents based on history of mutations performed on skills of the agents. For example, an agent whose skills have never been mutated in history may be preferred by the selection module 302. In another example, an agent whose skills have been mutated least number of time in a particular duration, may be preferred by the selection module 302. In yet another example, an agent whose performance is below a threshold level may be preferred by the selection module 302.

The selection module 302 may be further configured to provide the selection made from the database 310 to the mutation module 304. The mutation module 304 may query more information from the agent database 310 corresponding to the selected agent(s). Thereafter, based on certain predefined mutation rules, the mutation module 304 may mutate at least one attribute of skills of the selected agent (that is stored in the database). To explain reference of attribute of skills of agent an example is presented; if an agent have a skill of printer sales and is trained in selling laser and inkjet printers only, then the laser printer sales and inkjet printer sales are the attributes of the skill of the agents of selling printers.

Further, in an embodiment, mutation of skills refers to addition, deletion, or modification of attributes of skills of the agents that are stored in the agent database 310. Furthermore, the predefined mutation rules may include, but are not limited to, random addition, deletion, or modification of attributes of skills of the agents. The mutation rules may also include merging and pruning of attributes of skills of the agents. In an embodiment, the mutation rules may also include strategic addition, deletion, or modification of attributes of skills of the agents based on relevancy/irrelevancy from the known skills of the agents. The mutation module 304 may be configured to mutate the skills of the agents by modifying information stored in the agent database 310 related to the skills of the agents or may be configured to add the mutated skill data separately into the database 310.

Moreover, the mutation module 304 is configured to provide information corresponding to the mutated skills of the selected agent(s) to the update module 306. In an embodiment, the update module 306 may also access the agent database 310 to retrieve more information corresponding to the selected agent(s). The update module 306 may be configured to determine a level of mutation done by the mutation module 304 in the skills of the agent(s). The mutation module may refer to the old skills of agent(s) (before mutation) to compare with the mutated skill for determining level of the mutation. In an embodiment, the update module may depend upon certain pre-defined rules to determine level of mutation by comparing the old and mutated skills of the agent(s). Additionally, the update module 306 is configured to retrieve/receive a feedback on performance of the agent(s) in performing a work related to the mutated skills from either the agent database 310 or directly from the automatic call distributor 308 (ACD) of the call center. Further, the update module 306 may be configured to determine whether to terminate or retain the mutation performed by the mutation module on the skills of the selected agent(s) based on the determined level of mutation and the received performance feedback. High level of mutation and negative feedback may be a sign to terminate the mutation. However, low level of mutation and negative feedback may be a sign of retaining the mutation. Furthermore, different other heuristics could be applied to make this decision depending on the implementation of the update module (e.g., memory less termination, or history based termination).

In an embodiment, the ACD 308 is responsible for analyzing performance of the agent(s) in performing work related to the mutated skills. Further, as shown in the FIG. 3, the ACD 308 of the contact center may receive certain admin events and work events. The admin events may be provided by the administrator of the contact center and may relate to certain instructions for configuration of the ACD 308. Further, the work events may relate to inbound calls (work items) from the customers of the contact center which is required to be routed by the ACD 308 to at least one agent having suitable skills to handle the inbound call. In an embodiment, the ACD 308 may be configured to determine objective of the inbound call by connecting the inbound call with an automated system such as IVR system. After determining the objective of the work event, the ACD 308 may run a search query on the database 310 by providing work events attributes (objective of the work event) to the database. In return to the search query, the ACD 308 may retrieve a list of agents from the database 310 possessing relevant skills (agent attributes) for handling the work event. The ACD 308 may then select at least one most suitable agent from the list of agents based on agent's availability to allocate at least one work event.

After allocating at least one work event to the selected agent, the ACD 308 may start monitoring performance of the selected agent in handling the allocated work event. For example, if the work event is an inbound call from a customer of the contact center then the ACD 308 may be configured to analyze the communication between the selected agent and customer to determine performance of the selected agent. In an embodiment, the ACD 308 may use natural language processing algorithms to analyze the communication. In another embodiment, the ACD 308 may be configured to monitor duration of the call between the selected agent and the customer to determine performance of the selected agent. For example, if a call is disconnected by the customer before a pre-set time then the ACD 308 may assume that the customer was not happy after interacting with the selected agent. In yet another embodiment, the ACD 308 may be configured to monitor transfer-rate of calls from the selected agent to other agents with similar skills (as of the selected agent). Higher transfer-rate of calls may show that the selected agent does not really have skills that are required to handle the allocated work. However, lower or no transfer-rate of calls may suggest that the selected agent has the skills as required to handle the allocated work. Such monitored information may be stored into the agent database 310 by the ACD 308 or may be provided directly to the update module 306 by the ACD 308.

The update module 306 may determine whether or not the selected agent's skills were mutated. In case, if the update module 306 determines that the selected agent's skills were not mutated then the update module 306 may ignore the feedback by the ACD 308 or may store the feedback with mutation information in the agent database 310 for future reference. In case, if the update module 306 determines that the selected agent's skills were mutated then the update module 306 may determine a level of mutation in the skills of the selected agent. Thereafter, based on the level of mutation and the received performance feedback, the ACD 308 may use an artificial intelligent algorithm to determine whether to terminate or retain the mutation in the skills of the selected agent. Further insights of the artificial intelligence algorithm are detailed in conjunction with FIG. 4 of the present invention.

FIG. 4 is an illustration of an exemplary data structure of a mutation table 400 stored in the agent database 310. Column 402 in the mutation table 400 illustrates generations or degree of mutations performed on an agent's skills. For example, generation ‘0’ may suggest that no mutation has been performed on skills of an agent (as shown in column 404). Similarly, generation ‘1’ suggests one time mutation and generation ‘3’ suggests 3 times mutated skills of the agent (as shown in adjacent column 404). Further, column 404 suggests identity or name of an agent, whose skills are mutated according to the mutated table 400. Column 406 describes attributes of skills that are possessed by the agents (as shown in the column 404). Column 408 describes attributes of a work that is assigned to the agent (as shown in the column 404). More specifically, column 408 describes objective or properties related to work assigned to agents.

Column 410 illustrates a level of mutation that is determined based on the previous skills possessed by the agent (as shown in column 404) and the mutated skills as possessed currently by the agent (as shown in column 404). Column 412 illustrates a feedback concluded on performance of the agent (as shown in column 404) in performing a work having attributes as shown in consecutive column 408. Column 414 illustrates impact of mutation on the performance of the agent. Column 414 also suggests whether the mutation should be retained or terminated. Results of the column 414 are based on the data stored in the columns 410 and 412.

As shown in the mutation table 400, column 406 and 408 have values varying from A1 to A4 and B1 to B4. ‘A’ and ‘B’ represents two different skills (or sets of attributes) and attributes Ai and Bi are subsets of the skills ‘A’ and ‘B’. For example, skill A may describe ‘FurnitureSales’ with attributes such as ‘GardenFurniture’ (A1), ‘KitchenFurniture’ (A2), ‘LivingRoomFurniture’ (A3), ‘BedroomFurniture’ (A4). Similarly, skill B describes ‘OfficeSales’ with attributes such as ‘OfficeTechnology’ (B1), ‘OfficeCleaning’ (B2), ‘OfficeSupplies’ (B3), ‘OfficeFurniture’ (B4). It is to be noted that A1 to A4 are closely related to each other, same as the B1 to B4. However, A1-A4 and B1-B4 are different from each other as they belong to different skill sets.

Further, as shown in row of generation ‘0’, a partial match is noticeable between work and agent attributes. Since generation ‘0’ suggests no mutation in skills, the feedback (in column 412) has no impact on terminating or retaining mutation. Further, as shown in row of generation ‘1’, the third attribute of agent 1 can be noticed to be mutated (from A3 to A4) and a work has arrived matching exactly the agent attributes. Similarly, the third attribute of agent 2 can be noticed to be mutated (from B3 to B4) and a work has arrived matching exactly the agent attributes. Since for both agents (agent 1 and agent 2) mutation is within same skill set, the level of mutation (as show in column 410) is small. Therefore, it is less important to keep/reject (as shown in column 414) such a mutation based on the feedback (as shown in column 412).

As shown in row of generation ‘2’, it is noticeable that third attribute agent 1 is mutated from (A4 to B4) and no mutation is present in case of agent 2. Further, work for agent 1 has arrived matching only the mutated attribute of skill (B4). As the mutated attribute of agent 1 is different from actual skill of the agent 1, therefore the level of mutation is considered to be large (as shown in column 410). Furthermore, as feedback calculated for agent 1 (in column 412) is positive, therefore the mutation is highly desirable as it has been discovered that agent 1 has some new unique skill combination. Hence the impact is strong and it is desirable to retain the mutation (as shown in column 414). However, for agent 2 in the same situation the impact is much smaller as the level of mutation of the attribute is small.

Further, as shown in row of generation ‘3’, it is noticeable that there is no change in mutation level of agent 1 and hence impact of negative feedback on work of the agent 1 is neutral. However, change in the mutation level of agent 2 is noticeably large as the third attribute set is mutated from skill attribute B4 to skill attribute A2. Further, as the level of mutation is large in case of agent 2, therefore impact of the negative feedback is strong and such mutation must be terminated.

Furthermore, as shown in column 414, ‘neutral’ may suggest that there is no requirement of taking any action on mutated skill attributes of agents. Value ‘weak_remove’ and ‘weak_keep’ may suggest that there is no absolute necessity of retaining or terminating mutation and the agent with the mutated attributes can be given another work related to the mutated attributes. In case at least two ‘weak_remove’ or ‘weak_keep’ are noticed for a mutated attribute of an agent the mutated argument can be removed or retained respectively. Further, value ‘strong_remove’ and ‘strong_keep’ may suggest that the mutated attributes must be immediately removed or retained respectively.

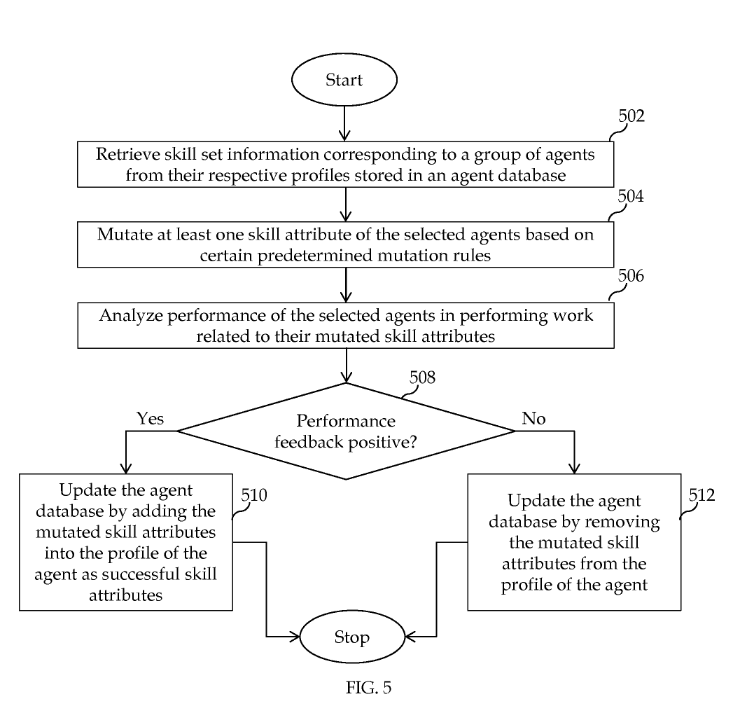

FIG. 5 is a flowchart of a method depicting an embodiment of the present invention. In step 502, at least one agent or a group of agents are selected based on certain pre-set rules. Thereafter, a database is accessed for retrieving information corresponding to their skills. In an embodiment, every agent may have a profile stored in the database. The profile may store personal as well as professional information related to the respective agents. In an embodiment the profiles of the agents may also store information related to skills of the agents. In an embodiment of the present invention, the step 502 may be performed by the selection module 302 (as shown in FIG. 3).

In step 504, the retrieved information related to the skills of the selected agents is mutated based on certain predefined mutation rules. The mutated information is again stored back to the database. In an embodiment, the mutation rules may include random addition, deletion, or modification in stored skill information of the agents. In an embodiment of the present invention, the step 504 may be performed by the mutation module 504.

In step 506, performance of the selected agents is analyzed for the mutated skill attributes. The agents may be provided with some work that is based on the mutated skill information of the agents. The agents are monitored to analyze their performance in handling work related to their mutated skills. For example if work for the agents is to sell furniture to customers via telephone calls, then communication between the agents and the customers may be monitored using natural language processing algorithms. Such algorithms may help in analyzing performance of the agents in the assigned work. In another embodiment, duration of call between agent and the customer may be monitored to determine performance of the selected agent. For example, if a call is disconnected by the customer before a pre-set time then it is determined that the customer was not happy after interacting with the selected agent. In yet another embodiment, transfer-rate of calls from the agent can also be monitored. Higher transfer-rate of calls may show negative performance of the agent and lower transfer-rate of calls may show positive performance of the agent. In an embodiment of the present invention, step 506 may be performed by the automatic call distributor 308.

In step 508, it is determined that whether the monitored performance of the agent in step 506 is negative or positive. In case, if the performance is determined to be positive then the method may proceed to step 510. Otherwise, if the performance is determined to be negative then the method may proceed to step 512. At step 510, the mutation performed on skills of the agent at step 504 is retained and the profile stored in the database is updated with the mutated skills of the agent. In an embodiment of the present invention, level of mutation achieved in step 504 may also be considered before retaining the mutation. For example, if the mutation achieved at the step 504 is determined to be a higher level of mutation (concept of higher and lower level of mutation is explained in conjunction with FIG. 4 of the present invention) then the mutation can be retained as positive feedback shows that the mutation was successful. However, if the level of mutation is determined to be of lower level then the mutation may or may not be retained (however mutation must not be deleted in either case). In an embodiment, the mutation may be retested to ensure that the mutation again receives positive feedback, in case of which the mutation must be retained.

At step 512, the mutation performed on skills of the agent at step 504 is terminated and database is updated by removing the mutated skills of the agent. In an embodiment of the present invention, level of mutation achieved in step 504 may also be considered before removing the mutation. For example, if the mutation achieved at the step 504 is determined to be a higher level of mutation (concept of higher and lower level of mutation is explained in conjunction with FIG. 4 of the present invention) then the mutation can be removed as received negative feedback shows that the mutation was not successful and could harm agent's performance. However, if the level of mutation is determined to be of lower level then the mutation may or may not be removed. In an embodiment, the mutation may be retested to determine whether or not the mutation repeatedly receives negative feedback, in case of which the mutation must be removed for the benefit of the agent and the contact center.

The exemplary systems and methods of this present invention have been described in relation to a contact center. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fibre optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example in one alternative embodiment, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A skill finding system for automated administration of employee skills in an enterprise, comprising:
a selection module configured to select at least one employee of the enterprise for skill mutation;
a mutation module configured to mutate at least one attribute of skill of the selected at least one employee based on predefined mutation rules, wherein the predefined mutation rules comprise rules to merge and to prune at least one attribute of skill of the selected at least one employee; and
an update module configured to update an employee database based on performance feedback of the selected at least one employee related to the mutated attribute of skill.

2. The skill finding system of claim 1, wherein the update module is further configured to determine a level of mutation in the attribute of skill of the selected at least one employee.

3. The skill finding system of claim 2, wherein the update module is further configured to update the employee database based on the performance feedback and the determined level of mutation in the mutated attribute of skill of the selected at least one employee.

4. The skill finding system of claim 2, wherein the employee database stores at least information related to skills and performance feedbacks of the employees of the enterprise.

5. The skill finding system of claim 2, wherein the update module is further configured to update the employee database by terminating the mutation from the mutated attribute of skill based on negative performance feedback of the selected at least one employee.

6. The skill finding system of claim 2, wherein the update module is further configured to add the mutated attribute of skill in the employee database based on positive performance feedback of the selected at least one employee.

7. The skill finding system of claim 1, wherein the performance feedback is based on duration of a call with a customer of the enterprise.

8. The skill finding system of claim 1, wherein the performance feedback is based on transfer-rate of calls by the selected at least one employee of the enterprise.

9. The skill finding system of claim 1, wherein the performance feedback is based on analysis of calls between the customers and the selected at least one employee of the enterprise.

10. The skill finding system of claim 1, wherein the predefined mutation rules comprise random addition, deletion or modification of skill information in the employee database.

11. A computer-implemented method for automated administration of employee skills in an enterprise, the method comprising:
selecting at least one employee data from an employee database and retrieving at least one attribute of skill from the selected data;
mutating the selected at least one attribute of skill based on predefined mutation rules, wherein the predefined mutation rules comprise rules to merge and to prune at least one attribute of skill of the selected at least one employee;
analyzing performance of the at least one employee in a work related to the mutated attribute of skill; and
updating the mutated data in the employee database based on the analyzed performance of the at least one employee in the mutated data.

12. The computer-implemented method of claim 11, wherein updating the mutated data comprises deleting the mutated data from the employee database based on analyzed negative performance of the at least one employee and level of mutation in the mutated data.

13. The computer-implemented method of claim 11, wherein updating the mutating data comprises retaining the mutated data in the employee database based on analyzed positive performance of the at least one employee and level of mutation in the mutated data.

14. (canceled)

15. The computer-implemented method of claim 11, wherein the mutation rules include random addition, deletion, and modification in the attributes of skills of the employees.

16. The computer-implemented method of claim 11, wherein the performance is analyzed based on duration of a call with a customer of the enterprise.

17. The computer-implemented method of claim 11, wherein the performance is analyzed based on feedback provided by customers of the enterprise.

18. The computer-implemented method of claim 11, wherein the performance is analyzed by monitoring transfer-rate of calls of the selected at least one employee of the enterprise.

19. The computer-implemented method of claim 11, wherein the performance is analyzed by monitoring calls between the customers and the selected at least one employee of the enterprise using natural language processing algorithm.

20. A computer-implemented method for automated administration of employee skills in an enterprise, the method comprising:
selecting at least one employee data from an employee database and retrieving at least one attribute of skill from the selected data;
mutating the selected at least one attribute of skill based on predefined mutation rules, wherein the predefined mutation rules comprise rules to merge and to prune at least one attribute of skill of the selected at least one employee;
analyzing performance of the at least one employee in a work related to the mutated attribute of skill; and
updating the mutated data in the employee database based on the analyzed performance of the at least one employee and a level of mutation in the mutated data.
